(19) United States
(12) Patent Application Publication
(10) Pub. No.: US 2003/0134596 A1
(43) Pub. Date: Jul. 17, 2003

(54) Bluetooth access point to provide more than seven users

(75) Inventor: Luke Zhu, Waterloo (CA)

Correspondence Address: Qiang Zhang, 81 Roger Valley Ct., Baltimore, MD, 21234, US

(73) Assignee: SuperBT Canada Inc., Waterloo (CA)

(21) Appl. No.: 10/338,870

(22) Filed: Jan. 9, 2003

Related U.S. Application Data
(60) Provisional application No. 60/347,089, filed on Jan. 11, 2002.

(51) Int. Cl. H04Q 7/20; H04B 5/00

(52) U.S. Cl. 455/41; 455/422

(57) ABSTRACT

The invention introduced in this patent application introduces a new Bluetooth Access Point, which applies the “sector idea” to its pico cell network and divides a pico cell into four (4) (but not limited to 4) pico sector of 90 degree. The access point thus implemented is denoted as Sectored Access Point. The Sectored Access Point utilizes only ONE microprocessor to communicate with four Bluetooth modules via either an embedded USB host controller with four ports to drive respective Bluetooth modules or UART interface with also ports to interface with respective Bluetooth modules. Each Bluetooth radio module acts as a master in its respective pico sector and takes care of up to seven (7) simultaneous Bluetooth enabled devices (called slaves in this cell). Therefore, the Access Point in this case can provide 28 users to access Internet at the same time, which is fourfold of any commercially available Bluetooth Access Point. The Sectored Access Point costs almost the same as normal access point, except 3 more Bluetooth radio modules and antennas, which contribute only about 10˜20% of extra cost, but increase the capacity by four times.

### CROSS REFERENCE CITED

| | | |
|---|---|---|
| 6,452,910,B1 | Sep. 17, 2002 | Vij et al. |
| 6,430,395 | Aug. 6, 2002 | Arazi, et al. |
| 6,326,926,B1 | Dec. 4, 2001 | Shoobridge et al. |

### BACKGROUND OF INVENTION

Bluetooth is a merging technology to provide short-range wireless connections as a cable replacement. Bluetooth technology offers the potential for low-cost, broadband wireless access for a range of mobile and portable devices. Operating in the unlicensed and widely available industrial, scientific and medical (ISM) applications band of 2.4 gigahertz (GHz), Bluetooth can support voice and data applications over a range of up to 100 meters and at speeds of up to one megabit per second (Mbps).

As technological advancements provide new and evolved applications, it is likely that there will be increased demand for general and personalized data services a scenario in which wireless access comes into its own.

Mobile devices can communicate within a small area to a Bluetooth Access Point (or Bluetooth server), which will then transmit voice or data signals along a fixed line. The size of a Bluetooth network is limited only by the number of Access Points deployed, and it's possible to switch seamlessly between Bluetooth and fixed-line. Bluetooth is a technology that lends itself to certain scenarios—the home, the office and public hotspots.

Home: Given that most people are relatively stationary at home, there is a case for installing a Bluetooth server to save on 3G airtime. Current fixed ISPs offer flat-rate services, which offer cheaper Internet accessing than current WAP or future 3G services.

Office: Most workers are relatively stationary within the office and access the Internet/intranet at their desks, making Bluetooth a viable option.

Public hotspots: These are places where there is a high density of people all with a need for customized information, e.g. airports, hotels, conference centers, train stations and campuses. For some applications, such as push advertising and transactions, it is likely that the prospective customer will be within 100 m of the shop in question, making it potential Bluetooth territory.

Stationary access: For many applications, it's likely that access won't be made on the move. Internet surfing, for example, lends itself to Internet cafes rather than walking down the street.

According to the Bluetooth V1.1 specification, each Bluetooth pico cell can only allow maximum of seven (7) simultaneously slaves to talk to one master. This situation is normally OK for example in a personal office or a small meeting room. However, at the public “hot spot”, like, airports, restaurants, coffee shops, shopping malls, etc., people would like to use their handheld devices, such as Pocket PCs, Personal Digital Assistants (PDAs) to get onto the Internet. There is a very high chance that more than 7 users want to log on to the Internet at the same time. Therefore, there is a strong desire to have a Bluetooth Access Point, which can handle more users at very competitive price.

### BRIEF SUMMARY OF THE INVENTION

The invention introduced in this patent application can solve above described problem. The Bluetooth Access Point based on this invention applies the “sector idea” to its pico-cell network and divides a pico cell into four (4) (but not limited to 4) pico sector of 90 degree. To distinguish this Access Point from normal Access Point, we denote it as Sectored Access Point. The Sectored Access Point utilizes an embedded USB host controller to drive 4 USB slave devices, which in this case, are Bluetooth radio modules. Each Bluetooth radio module acts as a master in its respective pico sector and takes care of up to seven (7) simultaneous Bluetooth enabled devices (called slaves in this cell). Therefore, the Sectored Access Point in this case can provide 28 users to access Internet at the same time, which is fourfold of any commercially available Bluetooth Access Point. The Sectored Access Point costs almost the same as normal access point, except 3 more Bluetooth radio modules and antennas, which contribute only about 10˜20% of extra cost, but increase the capacity by four times, since all Bluetooth modules are driven by a single microprocessor, sharing the same memory, operated by single software, and accessing the same Ethernet port.

### BRIEF DESCRIPTION OF THE DRAWINGS

FIG. 1 shows the Sectored Access Point and how 4 pico sectors of 90 degree are divided, where each sector takes care of up to 7 simultaneous users.

FIG. 2 illustrates an implementation example of the Sectored Bluetooth Access Point.

FIG. 3 shows the block diagram of the Sectored Access Point and how four (4) Bluetooth radio modules communicate with microprocessor via a USB host controller and send information forth and back from Ethernet via 10BaseT connection.

FIG. 4 shows the block diagram of the Sectored Access Point and how four (4) Bluetooth radio modules communicate with microprocessor via an alternative method through UART interface and send information forth and back from Ethernet via 10BaseT connection.

FIG. 5 provides a comparison of the signal coverage between sectored Bluetooth access point and normal Bluetooth access point

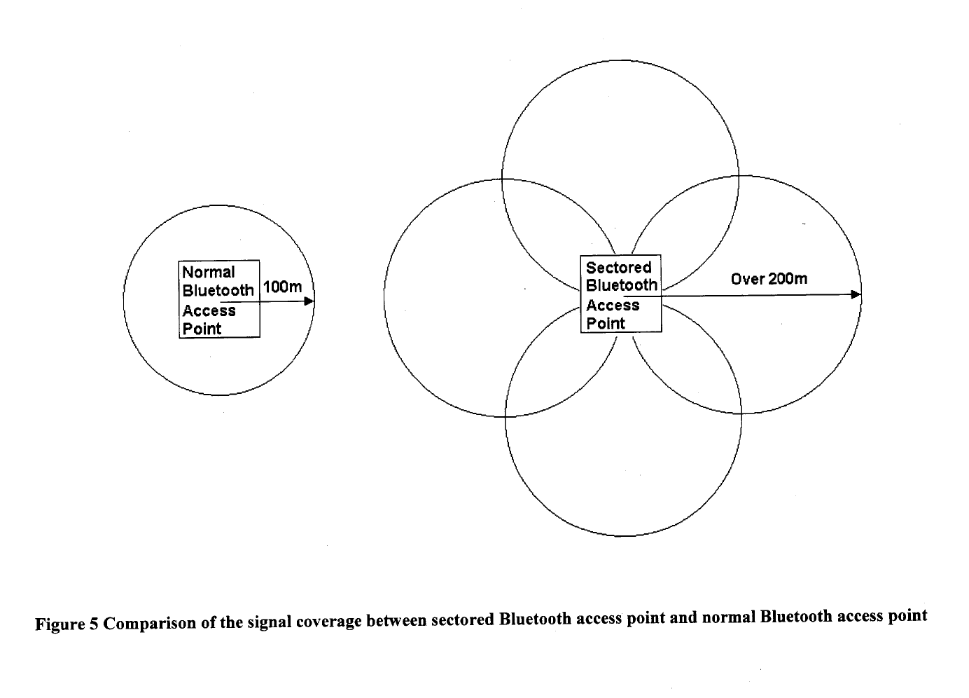

### DETAILED DESCRIPTION OF A PREFERRED EMBODIMENT

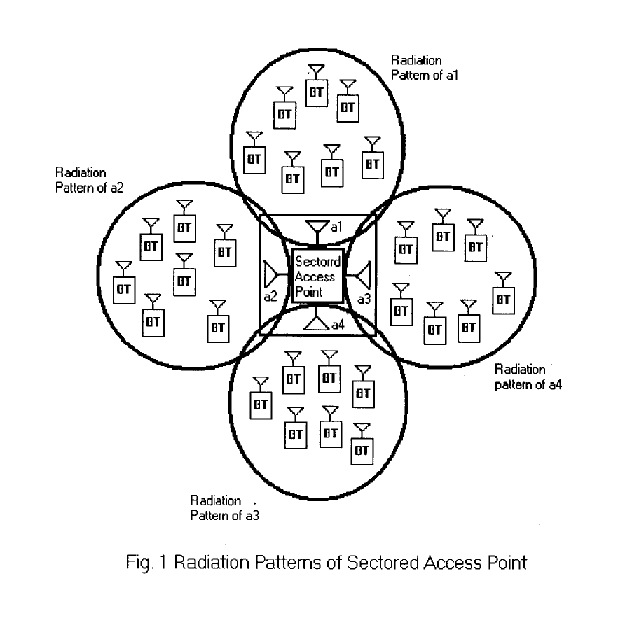

As shown in FIG. 1, the Sectored Access Point is connected to four antennas, denoted as a1, a2, a3, and a4, respectively. Each antenna is a 90 degrees sector antenna and has a radiation pattern covering about 90 degrees angle as shown in the FIG. 1. In each sector, up to 7 simultaneous Bluetooth enabled devices, denoted as BT, can be allowed to connect to their respective Bluetooth master to get onto the Internet.

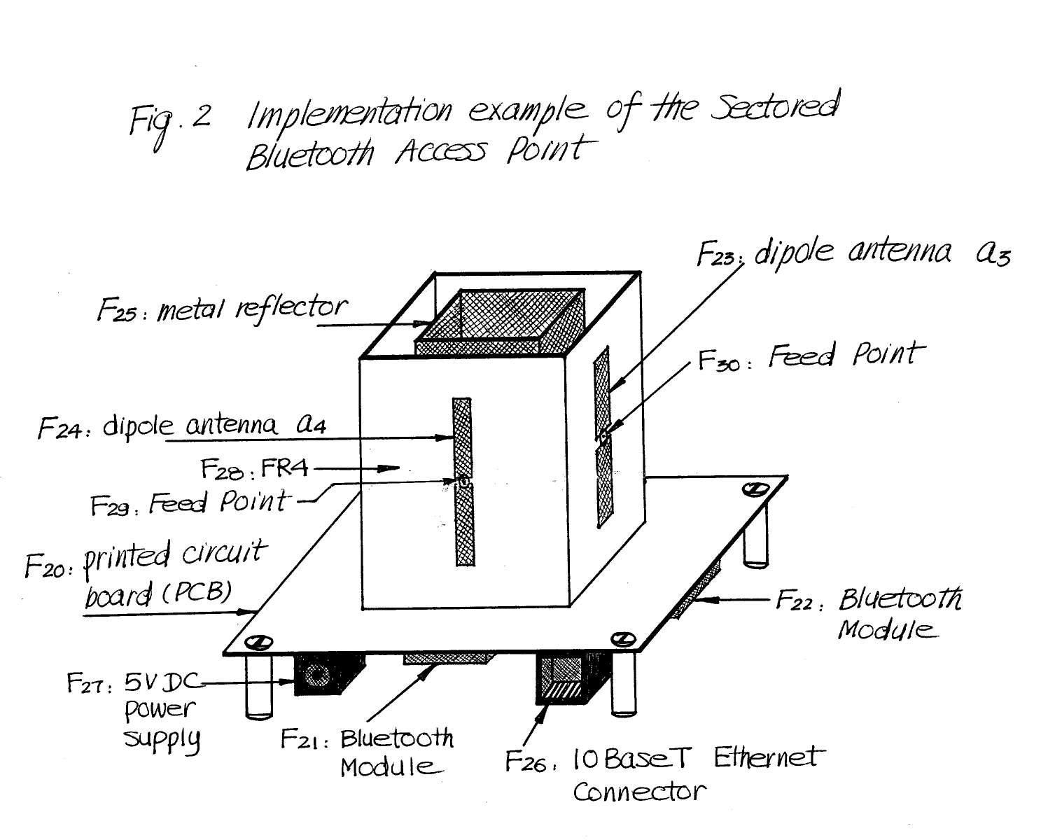

FIG. 2 gives an example of practical implementation of the four sectored Bluetooth access point, where the electrical circuit of the access point is built on the printed circuit board, denoted as F20. There are four Bluetooth modules mounted on the F20. You can see two out of the four from the FIG. 2, denoted as F21 and F22, respectively. For example, the Bluetooth module, F21, is connected to the feed point, F29, to send/receive RF signal to/from a dipole antenna a4, denoted here as F24, correspondingly. The dipole antenna is built on a FR4, the fiber glass material, F28, of 60 mils in thickness to form a sector antenna of 90 degrees 3 dB beam-width with one side of the metal reflector, F25. Similarly, another Bluetooth module, F22, is connected the another dipole antenna a3, denoted here as F23, correspondingly via a feed point, F30. This antenna forms another sector antenna of 90 degrees with another side of the same metal reflector, F25. FIG. 2 also shows a DC power supply jack, F27, which is mounted on the PCB, F20 and is used to supply DC power to the access point. Also, there is a 10BaseT Ethernet connector, F26, mounted on the board F20 as well, to provide Ethernet connection for the access point to the Internet.

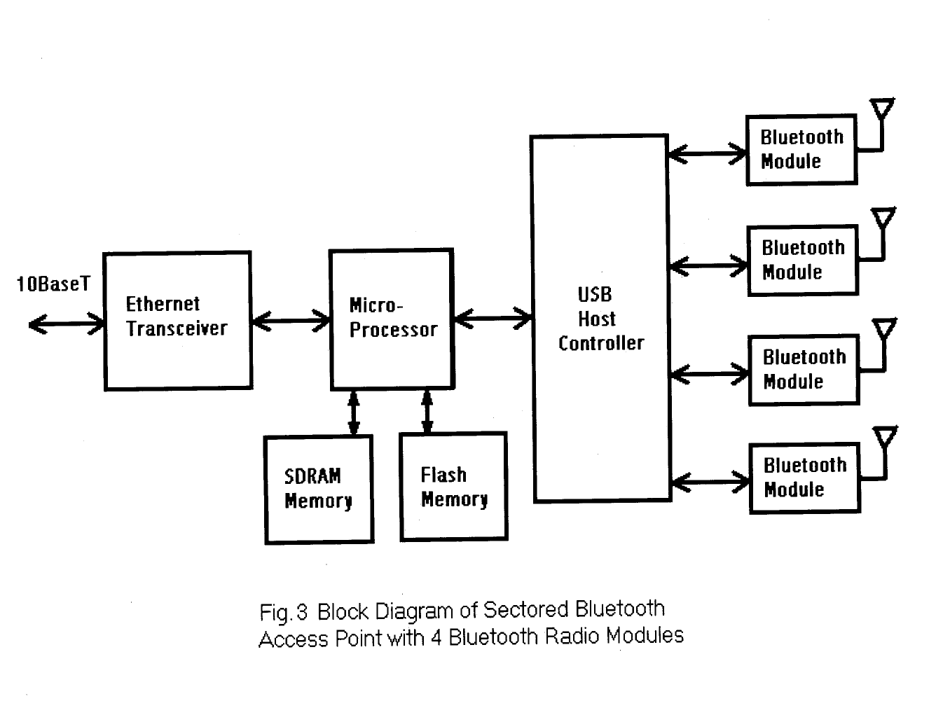

FIG. 3 provides an example of the practice implementation of the Sectored Bluetooth Access Point.

As shown in the FIG. 3, the Sectored Access Point consists of:

(1) An Ethernet transceiver to interface with external Internet or Intranet via 10BaseT wire connection;

(2) The Ethernet transceiver sends/receives packaged data to/from a microprocessor to process the data, where Flash memory and SDRAM memory host the control software and provide space for data coming and going;

(3) The microprocessor then sends/receives data to/from an embedded USB host controller, which can drive and communicate with up to 4 slave devices;

(4) Bluetooth radio module and its associated circuit consists of each of the USB slave devices and connects to the USB host controller via USB communication;

(5) Each Bluetooth radio module (denoted as Bluetooth master device) has an antenna connected to its input/output port as shown in FIG. 1 to transmit/receive Radio Frequency (RF) signal at 2.4 GHz ISM band to/from remote Bluetooth enabled systems (called Bluetooth slave devices);

(6) Each Bluetooth radio module is connected to a 90 degree sector antenna and cover a quarter of the pico net (i.e., a 90 degree sector out of 360 degree area), which is defined as Sector Pico net;

(7) In each Sector Pico net, the respective Bluetooth radio module in the Access Point is assigned as a master and can communicate with up to 7 Bluetooth enabled wireless devices (called Bluetooth slave devices) at 2.4 GHz ISM band;

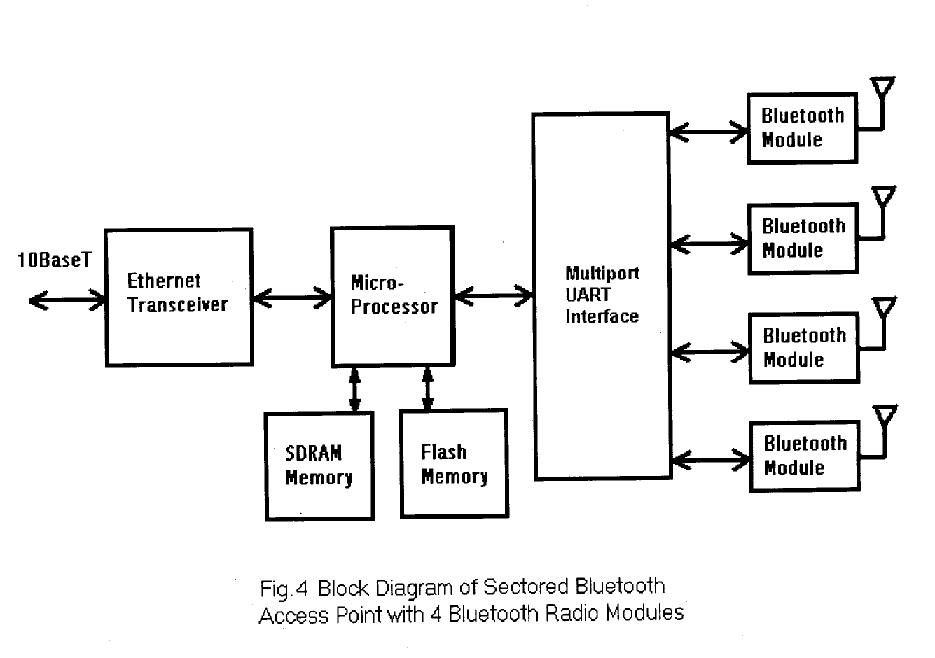

FIG. 4 provides an alternative example of the practice implementation of the Sectored Bluetooth Access Point utilizing UART interface than USB host controller to communicate with Bluetooth radio modules.

It should be emphasized that the FIGS. 3 and 4 give only two examples of how the Bluetooth modules are connected through either USB host controller or UART interface circuit. There could be other ways to drive Bluetooth modules, such as using I2C and PCM interface circuits. The patent application is targeted more to the concept of using more than one Bluetooth modules using one microprocessor, but not limited to certain interface circuit or the number of Bluetooth modules.

The advantages of the Sectored Access Points are as following in comparison with normal commercially available Bluetooth Access Points:

(1) Lower cost: The normal Bluetooth Access Point with 0 dBi omni-directional antenna gain and 20 dBm output power, the nominal coverage is about 100 m in radius. However, for the Sectored Access Point, the 90-degree sector antenna has about 7.5 dBi gain, which more than doubles the range (greater than 200 m in 90 degree sector). Therefore, the Sector Access Point extends the coverage over 200 m in radius, which is more than 4 times of the area that the normal Access Point can cover. In order to cover the same area, 4 or more normal Access Points are requires to provide the same capacity of user numbers, 4 normal Access Points will cost three times more than one Sectored Access Point. Beside, due to less access points installed in the same coverage area, the cost of wiring or infrastructure is much less and easy to be managed;

(2) Better Coverage: As described above, due to the advantage of the high gain sector antenna, the Sectored Access Point can offer much better coverage than the normal Access Point;

(3) Higher capacity: As described above also, the Sectored Access Point can provide fourfold of the capacity with only about 20˜30% of extra cost in comparison with the normal Access Point;

(4) Less interference: Since the radiation from one sector to most area of another sector is much less, except the overlap area, which is relatively small percentage. Even in this area, the Bluetooth slave device should have the choice to either log onto one sector or the neighbor sector without too very interference due to the good property of frequency hopping. Since the Bluetooth radios in each sector hop at the rate of 1600 frequencies/sec, the probability of frequency collision between the two sectors is very small. The small error or data lost due to the collision can be easily corrected with error correction algorithm built in different layers of Bluetooth stacks.

We claim:

1. A Bluetooth LAN Sectored Access Point as shown in FIG. 2 comprises an Ethernet transceiver, a microprocessor, Flash memory, SDRAM memory, an embedded USB host controller, which can drive and communicate with up to (but not limited to) 4 slave devices, 4 respective Bluetooth radio modules as USB slave devices, and 4 respective 90 degree sector antennas to cover a quarter of the piconet called Sector Piconet. Each Bluetooth radio module in the Access Point is assigned as a master and take care of each sector and can communicate with up to 7 Bluetooth enabled wireless devices (called Bluetooth slave devices) at 2.4 GHz ISM band.

2. The Sectored Access Point as defined in claim 1, said Sectored Access Point, which employs only ONE microprocessor to handle 4 Bluetooth communication traffic via USB host controller and send/receive data to/from Internet via Ethernet transceiver.

3. The Sectored Access Point as defined in claim 1, said Sectored Access Point, which utilizes the embedded USB host controller having four (4) slave ports to provide electrical connection with corresponding four (4) Bluetooth radio modules.

4. The Sectored Access Point, as defined in claim 1, comprises four Bluetooth radio modules, which behavior as the respective slave devices of the USB host controller and communicate with the USB via its four ports, respectively.

5. The Sectored Access Point, as defined in claim 1, has four Bluetooth radio modules, each plays a master role of the respective sector pico-net, where up to seven Bluetooth enabled devices (or called Bluetooth slaves) can be connected to the individual master, respectively.

6. The Sectored Access Point, as defined in claim 1, has four 90 degree sector antennas, which are used to connect to the respective Bluetooth radio module and provide coverage of 90 degree sector.

7. The Sectored Access Point, as defined in claim 1, contains the sector antenna, which can be any sector antenna either in the form of embedded internal antenna as shown in FIG. 2 or external sector antenna. The beam-width of the sector antenna can vary with respect to how many sectors are required in the Sectored Access Point.

8. The Sectored Access Point, as defined in claim 1, said the Internet access point, which can not only provide wireless local area data communication, such as Internet accessing for email and web browsing, but also provide analog voice, like coreless phone (based on Bluetooth specs. Rev 1.1) and VoIP, etc.

9. The Sectored Access Point, as defined in claim 1, said the Internet access point, which can be used for wireless data collection, such as barcode data via Bluetooth enabled barcode scanner (such as SuperBT's barcode scanner: SBT-800-BI).

10. The Sectored Access Point, as defined in claim 1, said the Internet access point, which can be used for wireless proximity identification, like Bluetooth enabled badge or any other Bluetooth enabled devices. The access point can identify any Bluetooth devices in the close proximity of its RF coverage range (such as SuperBT's Bluetooth badge: SBT-800-BG). The proximity information can be used to local certain users who carry Bluetooth enabled devices or goods to which the Bluetooth badges are attached.

11. The Sectored Access Point, as defined in claim 1, can use either on-board Bluetooth modules and antennas as shown in FIG. 2, or external Bluetooth USB dongle (such as SuperBT's Bluetooth USB dongle: SBT-100) via USB connector or cable.

12. The Sectored Access Point, as defined in claim 1, can be networked together via Ethernet connection to provide local area wireless access at public hotspots, such as airports, hotels, restaurants, cafes, etc.

13. The Sectored Access Point, as defined in claim 1, can be connected to Power Line Communication Modem via either USB or Ethernet via 10BaseT to make use of power line cable for local networking.

14. The Sectored Access Point, as defined in claim 1, can also be connected to cable or ADSL modem via 10BaseT connection to make use of boradband Internet wired access to a office or home.

15. The Sectored Access Point, as defined in claim 1, contains a Graphical User Interface (GUI) with built-in web server for remote management. This allows any IT people to configure and setup the access point either locally or remotely via Internet connection.

16. The Sectored Access Point, as defined in claim 1, contains also several networking and security features, such as DHCP, SNMP, Radius, VPN, etc. to allow efficient and secure wireless access.

17. A Bluetooth LAN Sectored Access Point as shown in FIG. 3 comprises an Ethernet transceiver, a microprocessor, Flash memory, SDRAM memory, an UART interface circuit which is either part of microprocessor or a separate chip to provide 4 UART (but not limited to 4) ports, which can drive and communicate with up to (but not limited to) 4 slave devices, 4 respective Bluetooth radio modules as UART terminal devices, and 4 respective 90 degree sector antennas to cover a quarter of the piconet called Sector Piconet. Each Bluetooth radio module in the Access Point is assigned as a master and take care of each sector and can communicate with up to 7 Bluetooth enabled wireless devices (called Bluetooth slave devices) at 2.4 GHz ISM band.

18. The Sectored Access Point as defined in claim 17, said Sectored Access Point, which employs only ONE microprocessor to handle 4 Bluetooth communication traffic via UART interface circuit and send/receive data to/from Internet via Ethernet transceiver.

19. The Sectored Access Point as defined in claim 17, said Sectored Access Point, which utilizes the UART interface circuit with four (4) ports to provide electrical connection with corresponding four (4) Bluetooth radio modules.

20. The Sectored Access Point, as defined in claim 17, comprises four Bluetooth radio modules, which connect to respective four UART ports and communicate with the microprocessor via the UART interface.
